(19) United States
(12) Patent Application Publication
(10) Pub. No.: US 2015/0354694 A1
(43) Pub. Date: Dec. 10, 2015

(54) SYSTEM AND METHOD FOR ASSEMBLING A PLANET CARRIER

(71) Applicant: Caterpillar Inc., Peoria, IL (US)

(72) Inventors: Justin M. Degenhart, Peoria, IL (US); James D. Hill, Brimfield, IL (US)

(21) Appl. No.: 14/299,100

(22) Filed: Jun. 9, 2014

(51) Int. Cl. F16H 57/08; B23P 15/14

(52) U.S. Cl. CPC F16H 57/082; B23P 15/14

(57) ABSTRACT

A planet carrier assembly is provided. The planet carrier assembly includes a housing having a plurality of holes provided therein. The planet carrier assembly includes a pin positioned within each of the plurality of holes. Each pin is configured to rotatably support a gear. The pin includes a retention groove provided at an end of the pin and least partially on a circumference thereof. The pin includes an orientation surface adjacent to and cooperating with the retention groove. The planet carrier assembly includes a plate having a plurality of slots provided thereon. Each of the plurality of slots is configured to engage with the respective pin. The plate is configured to angularly orient the pin within each of the plurality of holes in the housing during an assembly and to lock the pin within each of the plurality of holes in the housing after the assembly.

### TECHNICAL FIELD

The present disclosure relates to a system and method for assembling a planet carrier, and more specifically to a system and method for installing a gear and shaft assembly of the planet carrier.

### BACKGROUND

A planet carrier typically includes one or more pins or shafts to support one or more planet gears of the planet carrier. During assembly, the pins need to be angularly oriented within holes of the planet carrier in order to correctly align one or more lubrication holes, and so on. The pins are oriented within the respective holes manually and individually. This may make the assembly process laborious and time consuming Further, the individual pins are retained within the respective holes using one or more spring retention pins or other similar retention methods. This may lead to overall increase in the number of components used in the planet carrier assembly.

U.S. Pat. No. 7,695,399, hereinafter referred to as '399 patent, discloses a planet carrier assembly. The planet carrier assembly includes a housing member. The planet carrier assembly includes a plurality of pinion pins disposed in the housing member and rotatably supporting pinion gear members. The housing member has formed thereon a housing slot and a cavity. The planet carrier assembly includes a locator ring mounted on the housing member in a position to engage pinion slots formed in each of the pinion pins. The locator ring includes an inner rim having tab members formed thereon for engaging the housing slot. The locator ring includes protuberances formed thereon for engaging the cavity.

However, the '399 patent does not disclose a system or a method to angularly orient the pins or the shaft within the respective holes of the planet carrier. Hence, there is a need for an improved system and method for assembling the planet carrier.

### SUMMARY OF THE DISCLOSURE

In one aspect of the present disclosure, a planet carrier assembly is provided. The planet carrier assembly includes a housing having a plurality of holes provided therein. The planet carrier assembly also includes a pin positioned within each of the plurality of holes. Each pin is configured to rotatably support a gear. The pin includes a retention groove provided at an end of the pin and at least partially on a circumference thereof. The pin also includes an orientation surface adjacent to and cooperating with the retention groove. The planet carrier assembly further includes a plate having a plurality of slots provided thereon. Each of the plurality of slots is configured to engage with the respective pin. The plate is configured to angularly orient the pin within each of the plurality of holes in the housing during an assembly. The plate is also configured to lock the pin within each of the plurality of holes in the housing after the assembly.

In another aspect of the present disclosure, a method for installing and orienting a pin within each of a plurality of holes in a housing of a planet carrier assembly is provided. The method includes positioning a plate on the housing. The method includes positioning the pin through a slot in the plate and into the housing. The method further includes rotating the plate with respect to the housing. The method includes engaging an orientation surface of the pin with the slot in the plate. The method includes angularly orienting the pin within the slot based on the engagement. The method also includes engaging a retention groove of the pin with the slot in the plate. The method further includes locking the pin within the plate.

Other features and aspects of this disclosure will be apparent from the following description and the accompanying drawings.

### BRIEF DESCRIPTION OF THE DRAWINGS

FIG. 1 is an exploded view of an exemplary planet carrier assembly, according to an embodiment of the present disclosure;

FIG. 2 is a perspective view of a pin of the planet carrier assembly, according to an embodiment of the present disclosure;

FIG. 3 is a perspective view of a plate of the planet carrier assembly, according to an embodiment of the present disclosure;

FIGS. 4 to 8 are different views showing a method of assembling the planet carrier assembly, according to an embodiment of the present disclosure; and

FIG. 9 is a perspective view of an assembled planet carrier assembly, according to an embodiment of the present disclosure.

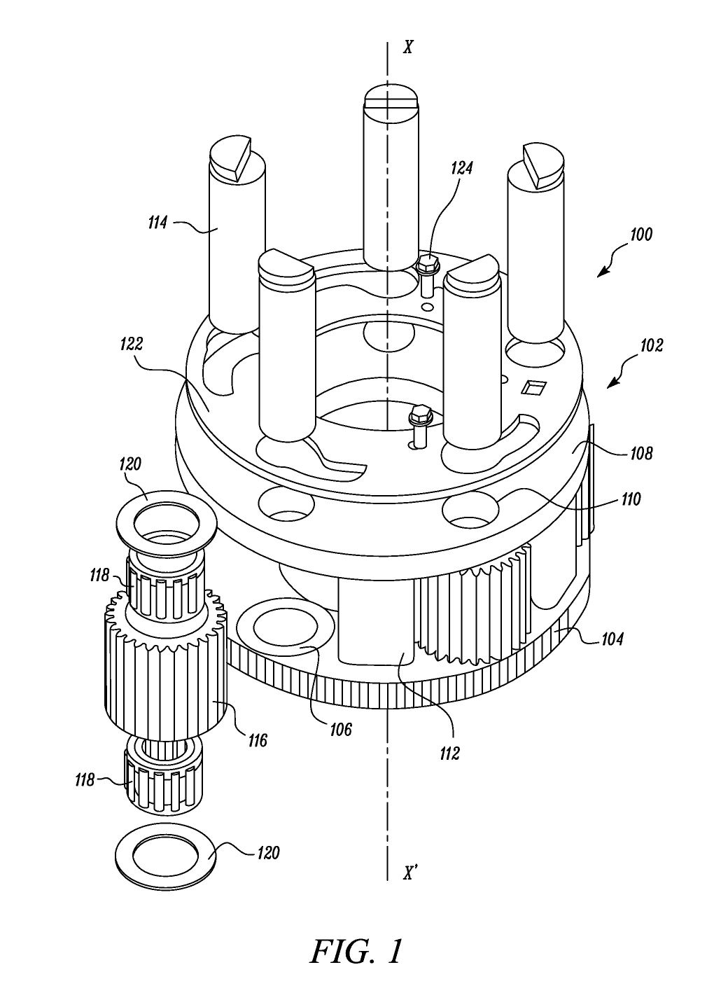

### DETAILED DESCRIPTION

Wherever possible, the same reference numbers will be used throughout the drawings to refer to the same or the like parts. Referring to FIG. 1, an exploded view of an exemplary planet carrier assembly 100, hereinafter referred to as the planet carrier 100, is illustrated. The planet carrier 100 may be associated with a transmission system (not shown) of a machine (not shown). The planet carrier 100 is configured to transfer motive power from one component of the transmission system to another component. In other embodiments, the planet carrier 100 may be any other component, such as a gear pump and so on, having a gear and shaft assembly.

The planet carrier 100 includes a housing 102. The housing 102 is circular in shape. In other embodiments, the housing 102 may have any other shape, such as polygonal. The housing 102 is configured to support various components of the planet carrier 100 which will be explained hereinafter in more detail. The housing 102 includes a first deck 104. The first deck 104 includes a plurality of holes 106 provided therein. Each of the plurality of holes 106 is equidistant from one another and equispaced about an axis X-X′. Each of the plurality of holes 106 is configured to support the components of the planet carrier 100.

The housing 102 includes a second deck 108 provided axially spaced apart from the first deck 104 with respect to the axis X-X′. The second deck 108 has a circular shape corresponding to the shape of the first deck 104. The second deck 108 includes a plurality of holes 110 provided thereon. Each of the plurality of holes 110 is provided spaced apart from one another. Additionally, each of the plurality of holes 110 is provided axially aligned with the respective hole 106 provided on the first deck 104 of the housing 102. Each of the plurality of holes 110 is configured to support the components of the planet carrier 100.

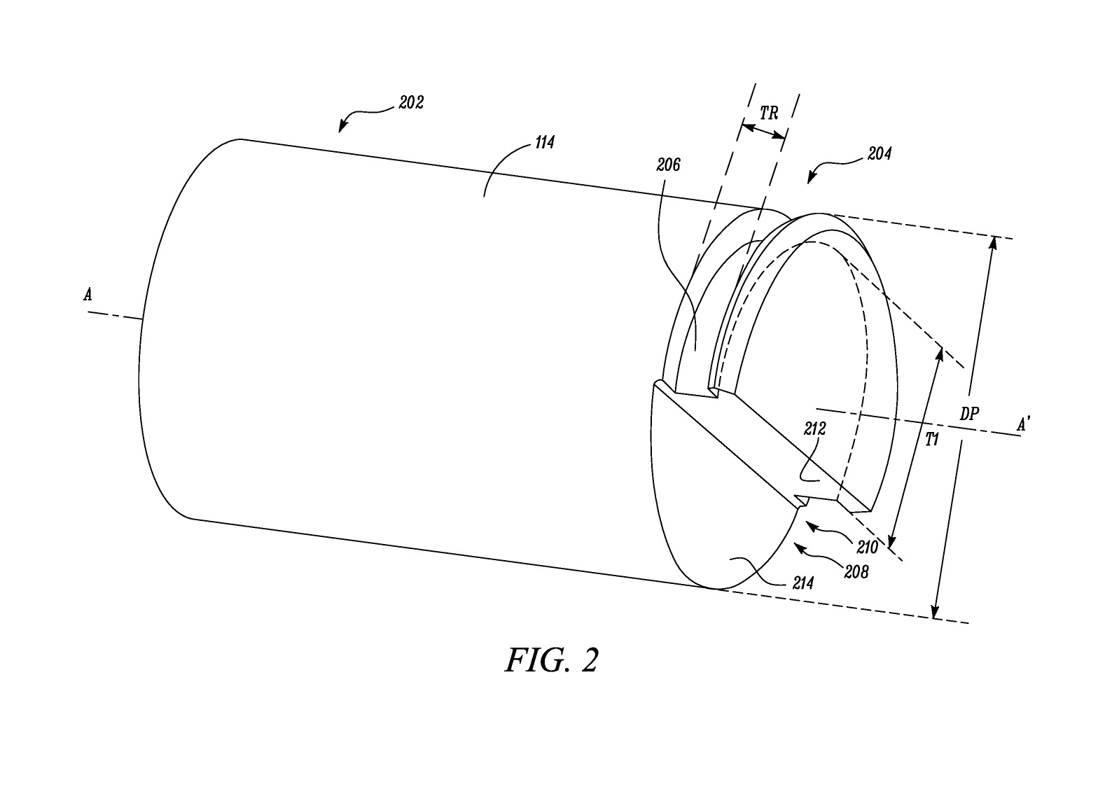

The housing 102 includes a plurality of posts 112 extending between the first deck 104 and the second deck 108. Each of the plurality of posts 112 may be configured to provide support and rigidity to the first deck 104 and the second deck 108. The planet carrier 100 includes a pin 114 positioned within each of the plurality of aligned holes 106, 110. Each pin 114 has an elongated, cylindrical shape having a diameter “DP” (shown in FIG. 2). Each pin 114 is configured to rotatably support one or more gears 116. Additionally, each pin 114 may also support one or more needle bearings 118, washers 120, bushings (not shown), and so on.

Referring to FIG. 2, a perspective view of a representative pin 114 is illustrated. The pin 114 includes a first end 202 and a second end 204. During assembly, the pin 114 is inserted through a pair of the hole 106 and the corresponding hole 110 axially aligned with one another. More specifically, the pin 114 is positioned such that the first end 202 is fixedly supported in the hole 106 and the second end 204 is fixedly supported in the hole 110.

The pin 114 includes a retention groove 206 provided on the second end 204. The retention groove 206 is provided at least partially on a circumference of the pin 114 having a thickness “TR”. In one embodiment, the retention groove 206 may extend halfway along the circumference of the pin 114. In another embodiment, the retention groove 206 may extend along a quarter of the circumference of the pin 114, and so on. The retention groove 206 is configured to lock the pin 114 in the respective pair of the holes 106, 110 and will be explained later in detail.

Additionally, the pin 114 includes an orientation surface 208 provided on the second end 204. The orientation surface 208 is provided adjacent to and in cooperation with the retention groove 206. The orientation surface 208 has a stepped configuration 210. More specifically, the stepped configuration 210 includes a first surface 212 and a second surface 214. The first surface 212 is parallel to a longitudinal axis A-A′ of the pin 114. The first surface 212 and the retention groove 206 define a distance “T1” therebetween. Further, the second surface 214 is perpendicular to the first surface 212. The orientation surface 208 is configured to angularly orient the pin 114 within the respective pair of the holes 106, 110 and will be explained later in detail.

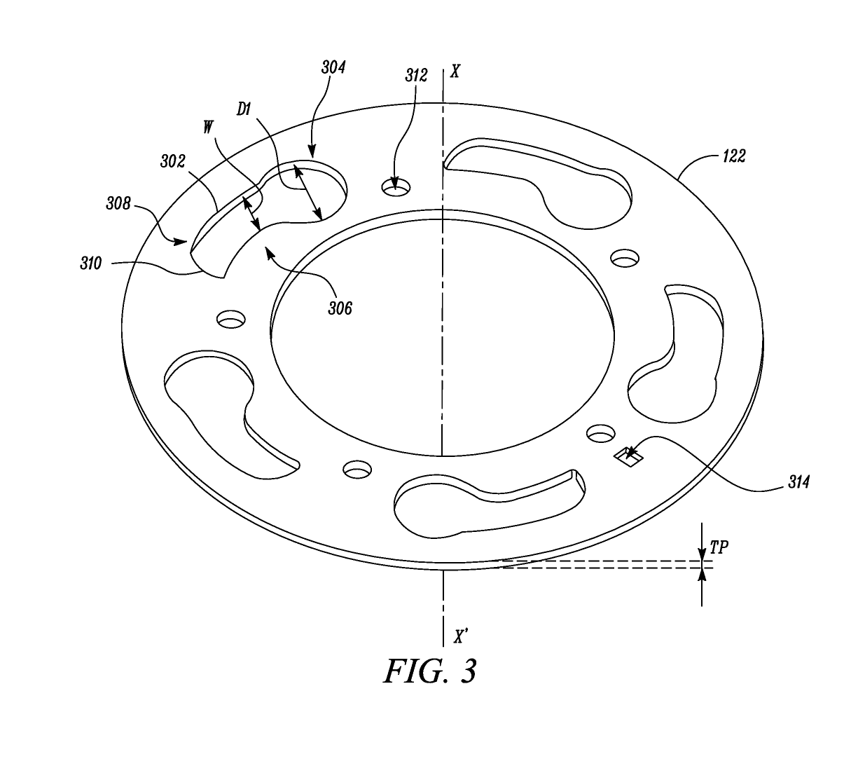

Referring to FIG. 1, the planet carrier 100 also includes a plate 122. The plate 122 will be explained in more detail with reference to FIG. 3. Referring to FIG. 3, a perspective view of the plate 122 of the planet carrier 100 is illustrated. The plate 122 has a circular cross section having a thickness “TP”. The thickness “TP” of the plate 122 is approximately equal to the thickness “TR” of the retention groove 206. The plate 122 includes a plurality of slots 302 provided thereon. Each of the plurality of slots 302 is provided spaced apart from one another. Additionally, each of the plurality of slots 302 is equidistant from one another and equispaced about the axis X-X′. Further, each of the plurality of slots 302 has an arcuate shape.

The slot 302 includes a first portion 304, a second portion 306 and a third portion 308. The first portion 304 is sized larger than the second and third portions 306, 308. Further, the second portion 306 is sized approximately equal to the third portion 308. The first portion 304 has a shape approximately equal to a circular sector of approximately 270 degrees defining a diameter “D1”. The first portion 304 is configured to receive the pin 114 therethrough during the assembly of the planet carrier 100. Accordingly, the first portion 304 is sized based on the diameter “DP” of the pin 114. More specifically, the diameter “D1” of the first portion 304 may be approximately equal to or greater than the diameter “DP” of the pin 114.

The slot 302 includes the second portion 306. The second portion 306 is provided adjacent to and in cooperation with the first portion 304. The second portion 306 has a curved configuration defining a width “W”. The width “W” is smaller than the diameter “D1” of the first portion 304. The width “W” is approximately equal to the distance “T1” between the retention groove 206 and the first surface 212 of the orientation surface 208. More specifically, the second portion 306 is sized based on a surface area of contact of the first surface 212 of the orientation surface 208 and the retention groove 206. Accordingly, the second portion 306 may be profiled in a manner to allow sliding of the orientation surface 208 against the second portion 306 during rotation of the plate 122 about the axis X-X′. The second portion 306 is configured to contact the orientation surface 208 on rotation of the plate 122 about the axis X-X′ during the assembly of the planet carrier 100. Accordingly, the second portion 306 is configured to angularly orient the pin 114 within the respective pair of the holes 106, 110.

The slot 302 includes the third portion 308. The third portion 308 is provided adjacent to and in cooperation with the second portion 306. The third portion 308 has an elongated curved configuration. The third portion 308 has a width “W1” equal to that of the second portion 306. Accordingly, the third portion 308 is sized based on the surface area of contact of the first surface 212 of the orientation surface 208 and the retention groove 206. Further, the third portion 308 includes an end portion 310. The end portion 310 has a shape corresponding at least partially to a shape of the retention groove 206. The third portion 308 is configured to at least partially engage with the retention groove 206 and the orientation surface 208 on rotation of the plate 122 about the axis X-X′ during the assembly of the planet carrier 100. The third portion 308 is configured to lock the pin 114 within the respective pair of the holes 106, 110 after the assembly of the planet carrier 100.

The plate 122 includes at least one hole 312 provided therein. The hole 312 is configured to receive a mechanical fastener 124 (shown in FIG. 1) such as a bolt, a screw and so on. The mechanical fastener 124 is configured to affix the plate 122 to the second deck 108 of the housing 102 after the assembly of the planet carrier 100. The plate 122 also includes at least one notch 314 provided thereon. The notch 314 is configured to receive a tool (not shown), such as a wrench and so on, for rotating the plate 122 about the axis X-X′ during the assembly of the planet carrier 100.

### INDUSTRIAL APPLICABILITY

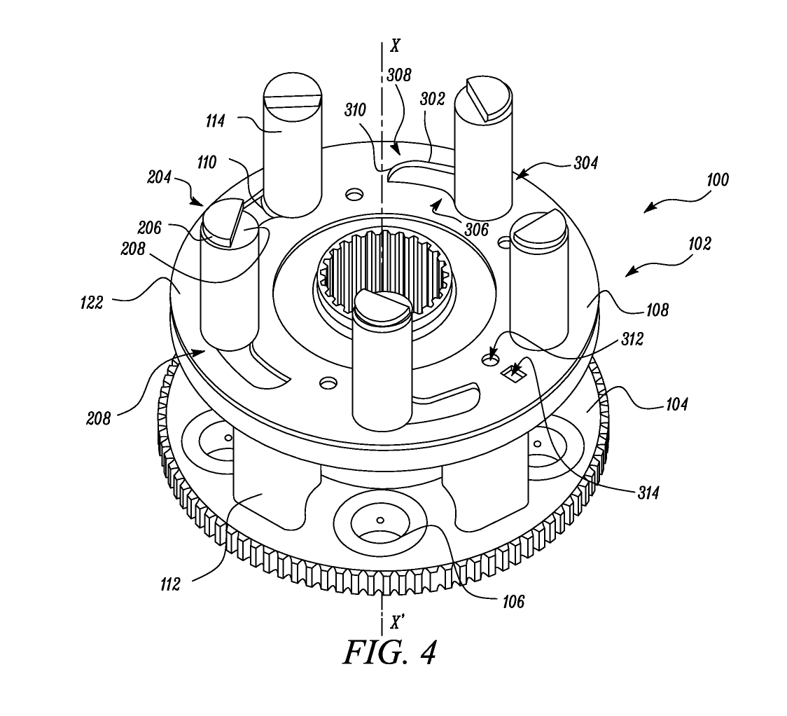

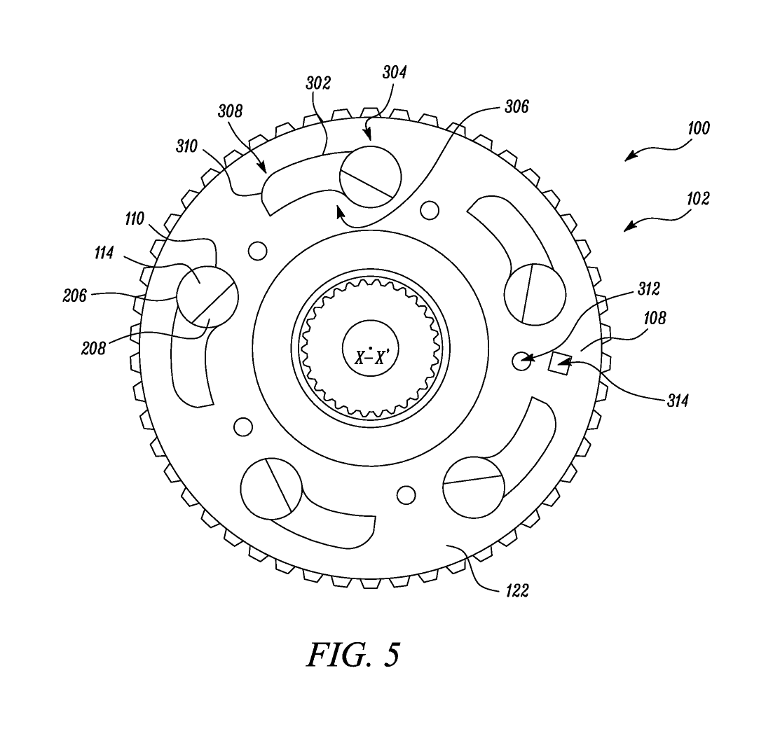

The method of assembling the planet carrier 100 will now be explained with reference to FIGS. 4 to 8. Referring to FIG. 4, the plate 122 is positioned on the second deck 108 of the housing 102. The plate 122 is positioned such that the first portion 304 of each of the plurality of slots 302 is aligned with each of the plurality of holes 110. As shown in FIG. 5, the pin 114 is positioned through the slot 302 in the plate 122 and into the housing 102. More specifically, the pin 114 is positioned through the first portion 304 of each of the plurality of slots 302 and each of the plurality of holes 110. The pin 114 is further positioned through the needle bearings 118 (shown in FIG. 1) and the gear 116 (shown in FIG. 1). Accordingly, each pin 114 rotatably supports the needle bearings 118, the washers 120 and the gear 116.

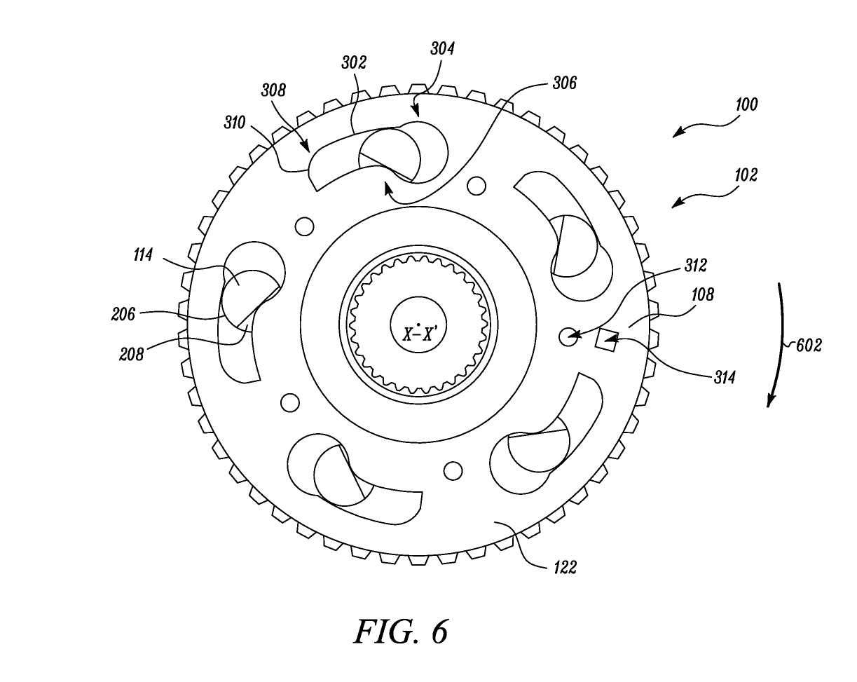

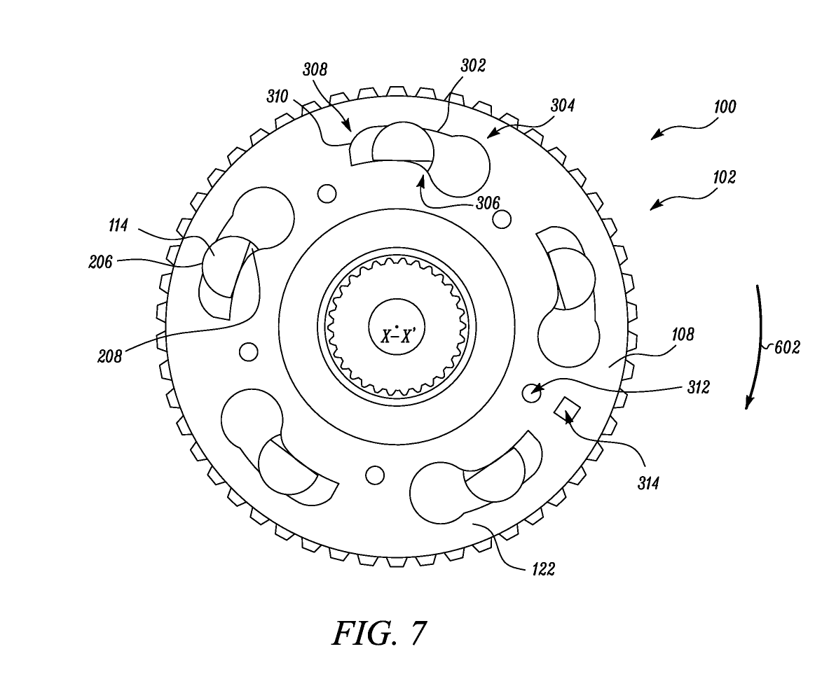

Referring to FIG. 6, the plate 122 is rotated with respect to the housing 102 about the axis X-X′ in a clockwise direction 602. The plate 122 is rotated by using the tool. The tool is engaged in the notch 314 provided in the plate 122 and rotated therewith. The rotation of the plate 122 engages the orientation surface 208 of the pin 114 with the slot 302 in the plate 122. More specifically, the rotation of the plate 122 engages the orientation surface 208 of each of pins 114 with the second portion 306 of each of the plurality of slots 302. Based on the engagement, as shown in FIG. 7, each pin 114 is angularly oriented within the respective slot 302. The pin 114 may be angularly oriented in order to align one or more lubrication holes (not shown) provided in the pin 114 with the lubrication holes (not shown) provided in the housing 102.

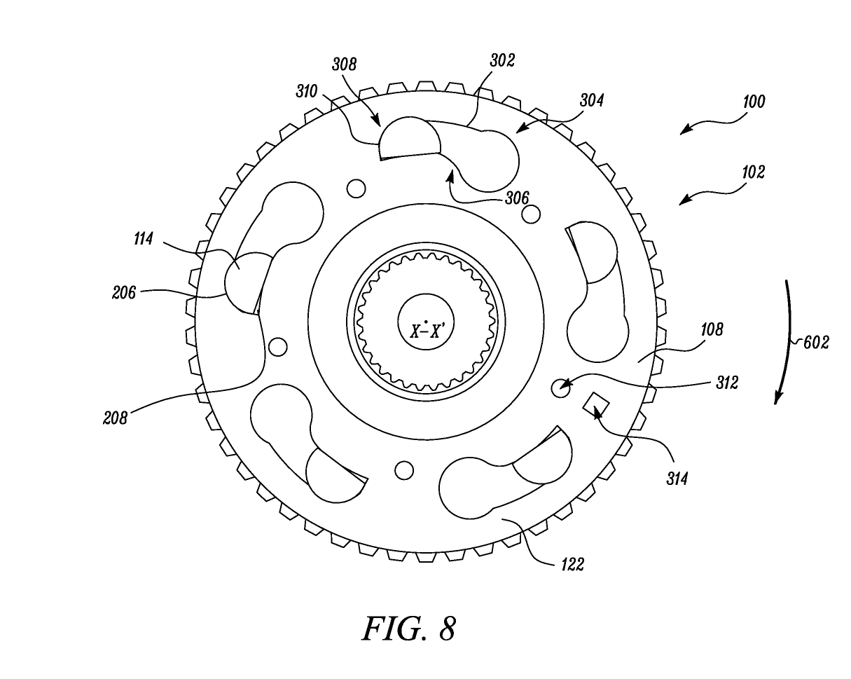

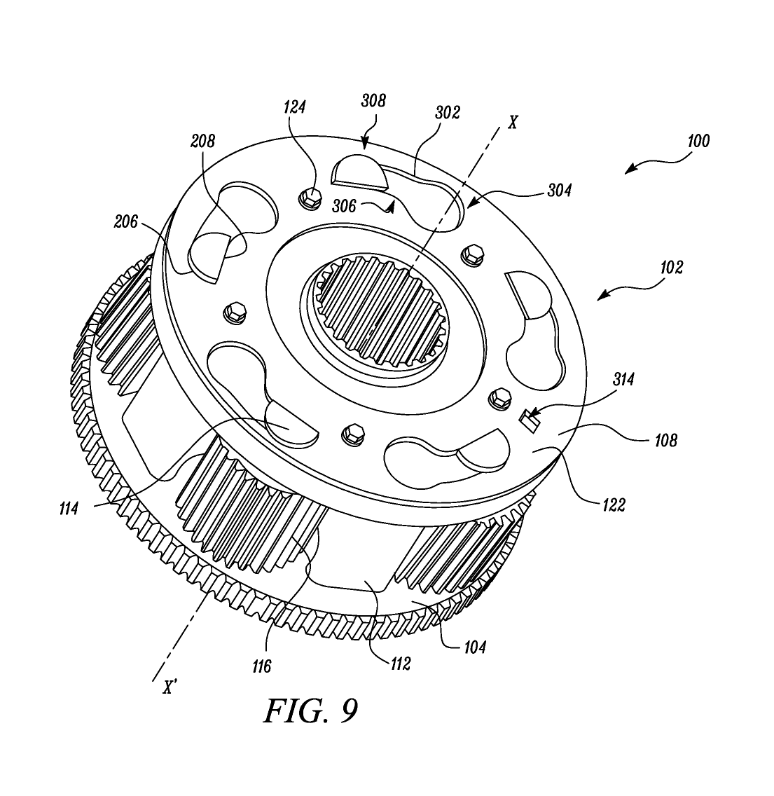

As shown in FIG. 8, the plate 122 is further rotated with respect to the housing 102 about the axis X-X′ in the clockwise direction 602. It should be noted that the clockwise direction 602 of rotation of the plate 122 is merely exemplary. In other embodiments, the plate 122 may be rotated in an anticlockwise direction (not shown) based on positioning of the second and third portions 306, 308 with respect to the first portion 304. The rotation of the plate 122 leads to engagement of the retention groove 206 of the pin 114 with the slot 302 in the plate 122. More specifically, the rotation of the plate 122 results in engagement of the retention groove 206 of each of the pins 114 with the third portion 308 of each of the plurality of slots 302. Based on the engagement, each pin 114 is locked within the respective slot 302. Referring to FIG. 9, a perspective view of the planet carrier 100 in the assembled position is illustrated. After each pin 114 is angularly oriented and locked by the plate 122 in the respective slot 302, the mechanical fastener 124 is provided through the holes 312 to attach the plate 122 to the second deck 108 of the housing 102.

The present disclosure discloses the plate 122 for the planet carrier 100 which may be used for both aligning of the pins 114 as well as locking the pins 114 within the housing 102. The disclosed system and method may reduce assembly time by aligning all the pins 114 of the planet carrier 100 simultaneously. Further, the plate 122 locks all the pins 114 together, thereby avoiding usage of additional spring retention pins or other similar retention methods. As a result, a number of components of the planet carrier 100 may be reduced.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A planet carrier assembly comprising:
a housing having a plurality of holes provided therein;
a pin positioned within each of the plurality of holes, each pin configured to rotatably support a gear, each pin including:
a retention groove provided at an end of the pin and at least partially on a circumference thereof; and
an orientation surface adjacent to and cooperating with the retention groove; and
a plate having a plurality of slots provided thereon, each of the plurality of slots configured to engage with the respective pin, wherein the plate is configured to:
angularly orient the pin within each of the plurality of holes in the housing during an assembly; and
lock the pin within each of the plurality of holes in the housing after the assembly.

2. The planet carrier assembly of claim 1, wherein each of the plurality of slots further comprises:
a first portion configured to receive the pin therethrough;
a second portion provided adjacent to the first portion, the second portion configured to angularly orient the pin within each of the plurality of holes in the housing during the assembly; and
a third portion provided adjacent to the second portion, the third portion configured to lock the pin within each of the plurality of holes in the housing after the assembly.

3. The planet carrier assembly of claim 2, wherein the first portion of the slot is sized based on a diameter of the pin.

4. The planet carrier assembly of claim 2, wherein the first portion is sized larger than the second and third portions.

5. The planet carrier assembly of claim 2, wherein the second and third portions are sized based on a surface area of contact of the orientation surface and the retention groove provided on the pin.

6. The planet carrier assembly of claim 1, wherein each of plurality of slots have an arcuate shape.

7. The planet carrier assembly of claim 1, wherein the plate includes at least one notch configured to receive a tool for rotating the plate during the assembly.

8. The planet carrier assembly of claim 1, wherein the orientation surface has a stepped configuration.

9. The planet carrier assembly of claim 1, wherein a thickness of the retention groove is equal to a thickness of the plate.

10. A method for installing and orienting a pin within each of a plurality of holes in a housing of a planet carrier assembly, the method comprising:
positioning a plate on the housing;
positioning the pin through a slot in the plate and into the housing;
rotating the plate with respect to the housing;
engaging an orientation surface of the pin with the slot in the plate;
angularly orienting the pin within the slot based on the engagement;
engaging a retention groove of the pin with the slot in the plate; and
locking the pin within the plate.

11. The method of claim 11, wherein positioning the pin in the housing further including:
rotatably supporting a gear on each pin in the housing.

12. The method of claim 11, further including:
rotatably supporting the gear on each pin by needle bearings.

13. The method of claim 11, wherein positioning of the plate on the housing includes:
aligning a first portion of the slot with each of the plurality of holes in the housing.

14. The method of claim 11, wherein engaging an orientation surface of the pin with the slot in the plate includes:
engaging the orientation surface of the pin with a second portion of the slot.

15. The method of claim 11, wherein engaging a retention groove of the pin with the slot includes:
engaging a retention groove of the pin with a third portion of the slot.

16. The method of claim 11 further including:
attaching the plate to the housing using mechanical fasteners.

17. The method of claim 11, wherein rotating the plate is performed by use of a tool.
